(19) United States
(12) Patent Application Publication
(10) Pub. No.: US 2026/0368065 A1
(43) Pub. Date: Nov. 19, 2026

(54) TESTING APPARATUS AND METHOD FOR HIGH-SPEED INTERCONNECT LOSS ESTIMATION AND SIGNAL-PERFORMANCE VERIFICATION

(71) Applicant: Aivres Systems Inc., Fremont, CA (US)

(72) Inventor: Yuan Hao WANG, Chiayi City (TW)

(21) Appl. No.: 19/726,272

(22) Filed: Jun. 30, 2026

(51) Int. Cl. G06F 11/34

(52) U.S. Cl. CPC G06F 11/349

(57) ABSTRACT

A testing apparatus for an interconnect under test includes a transmitter, an interconnect, a signal-routing circuit, a measurement interface, and a controller. The signal-routing circuit includes a compensation path having a controllable compensation circuit and a bypass path that bypasses the controllable compensation circuit. In a first mode, the controller routes a test signal through the compensation path, the interconnect, and the interconnect under test, adjusts the controllable compensation circuit until first signal-metric data satisfies a reference condition, and determines an inferred loss value representative of loss of the interconnect under test based on an adjusted state of the controllable compensation circuit. In a second mode, the controller routes the test signal through the bypass path, the interconnect, and the interconnect under test while bypassing the controllable compensation circuit, and determines a de-embedded performance metric based on second signal-metric data and baseline de-embedding data associated with the interconnect.

### TECHNICAL FIELD

The present disclosure relates generally to testing of high-speed electrical interconnects. More particularly, the present disclosure relates to apparatuses and methods for testing an interconnect under test using an active signal path having a controllable compensation circuit and a bypass path, determining an inferred loss value from an adjusted state of the controllable compensation circuit, as well as a de-embedded performance metric from signal-metric data obtained while bypassing the controllable compensation circuit.

### BACKGROUND

With the rapid advancement of high-speed interconnect standards to transmission rates of 64 GT/s and beyond, and the increasing adoption of multi-level modulation schemes such as pulse-amplitude modulation with four levels (PAM4), the allowable budget for channel loss and signal-integrity degradation in high-speed links has become extremely limited. Accurately evaluating the loss and signal-integrity contribution of a high-speed interconnect, such as a cable assembly, while maintaining low cost and high throughput in a real active system environment, remains a significant technical challenge. Existing approaches to testing high-speed interconnects may face limitations relating to equipment cost, inability to isolate the loss contribution of the interconnect under test from fixture and system effects, dependence on vendor-specific implementations, and difficulty in converting measurement results into absolute, quantifiable physical loss values suitable for objective quality-control inspection. Accordingly, there is a need for an automated test architecture capable of operating in a real active signal environment, rapidly estimating loss attributable to a high-speed interconnect while accounting for fixture effects, generating objective signal-performance metrics, and supporting mass-production screening and closed-loop process control.

### SUMMARY

In one general aspect, a testing apparatus for an interconnect under test may include a transmitter configured to generate a test signal, a fixed interconnect configured to couple the transmitter to the interconnect under test, a signal-routing circuit comprising a compensation path comprising a controllable compensation circuit and a bypass path bypassing the controllable compensation circuit, a measurement interface configured to receive signal-metric data corresponding to the test signal after propagation through the interconnect under test, and a controller.

The controller may be configured to, in a first mode, cause the test signal to be routed through the compensation path, the fixed interconnect, and the interconnect under test, adjust the controllable compensation circuit until first signal-metric data received from the measurement interface satisfies a reference condition, and determine an inferred loss value representative of loss of the interconnect under test based on an adjusted state of the controllable compensation circuit.

The controller may be further configured to, in a second mode, cause the test signal to be routed through the bypass path, the fixed interconnect, and the interconnect under test while bypassing the controllable compensation circuit, and determine a de-embedded performance metric of the interconnect under test based on second signal-metric data received from the measurement interface and baseline de-embedding data associated with the fixed interconnect.

Other embodiments of this aspect include corresponding methods, computer systems, and computer programs recorded on one or more computer storage devices, each configured to perform the actions described herein.

Implementations may include one or more of the following features.

The controller may be further configured to store compensation calibration data that correlates a plurality of control states of the controllable compensation circuit to a plurality of loss-compensation values, each control state comprising one or more programmable settings of the controllable compensation circuit and each loss-compensation value representing a corresponding amount of channel-loss compensation provided by the controllable compensation circuit. The controller may determine the inferred loss value by matching the adjusted state of the controllable compensation circuit to a corresponding loss-compensation value in the stored compensation calibration data, after the first signal-metric data satisfies the reference condition.

The controllable compensation circuit may comprise at least one of a redriver, a retimer, a continuous-time linear equalizer, a feed-forward equalizer, or a decision-feedback equalizer. The adjusted state may comprise at least one of a gain setting, an equalization setting, a peaking setting, a tap-coefficient setting, or a digital register value of the controllable compensation circuit.

The controller may be further configured to establish the reference condition prior to testing the interconnect under test by routing the test signal through a reference path having a target channel loss, placing the controllable compensation circuit in a known reference state, and measuring a baseline signal-integrity metric.

The first signal-metric data and the second signal-metric data may comprise at least one of an eye height, an eye width, a vertical eye closure, a bit-error-rate estimate, or a multi-level signal metric. The multi-level signal metric may comprise at least one of a plurality of eye openings, a level-separation metric, or a linearity metric of a multi-level modulated signal.

The interconnect under test may comprise a plurality of high-speed channels. The controller may be configured to execute the first mode on a specific channel of the plurality of high-speed channels while adjacent channels are in an inactive state, to determine a single-channel inferred loss value for the specific channel. The controller may be further configured to execute the first mode on the specific channel while the adjacent channels transmit active signal patterns to determine a multi-channel inferred loss value, the active signal patterns comprising at least one of pseudo-random binary sequences, compliance test patterns, stress patterns, or protocol traffic patterns. The controller may determine a multi-channel impairment value associated with crosstalk by calculating a difference between the single-channel inferred loss value and the multi-channel inferred loss value, the multi-channel impairment value representing an additional loss, margin reduction, or compensation requirement caused by simultaneous operation of multiple channels of the interconnect under test.

The controller may be further configured to generate a per-cable quality determination by comparing the inferred loss value against a target loss specification and comparing the de-embedded performance metric against an active eye-mask threshold, and to classify the interconnect under test as passing, failing, or belonging to a predetermined quality bin based on the comparisons.

The controller may be configured to aggregate the inferred loss value and the de-embedded performance metric across a batch of tested interconnects to compute a statistical process-capability indicator based on a distribution of at least one selected quality characteristic of the batch relative to one or more specification limits. The controller may be configured to issue a closed-loop control action to upstream manufacturing equipment when the statistical process-capability indicator drops below a predetermined limit, the closed-loop control action comprising at least one of generating an alarm, causing sorting or isolation of a tested interconnect, stopping or pausing a production process, or transmitting a correction parameter to the upstream manufacturing equipment.

The signal-routing circuit may comprise an electronic switching element configured to selectively transition the test signal between the compensation path and the bypass path without requiring physical disconnection of the interconnect under test.

The baseline de-embedding data may comprise at least one of S-parameters, a transfer function, a loss-versus-frequency table, a time-domain impulse response, a polynomial model, or a correction matrix characterizing signal effects of the fixed interconnect.

The test signal may comply with a high-speed serial communication protocol selected from the group consisting of Peripheral Component Interconnect Express (PCIe), Compute Express Link (CXL), Ethernet, InfiniBand, Universal Accelerator Link (UALink), Universal Serial Bus (USB), and Thunderbolt.

In one general aspect, a method for testing an interconnect under test using a testing apparatus comprising a transmitter, a fixed interconnect, a signal-routing circuit comprising a compensation path and a bypass path, a measurement interface, and a controller may include generating, by the transmitter, a test signal.

The method may also include, in a first mode, routing the test signal through the compensation path, the fixed interconnect, and the interconnect under test, the compensation path comprising a controllable compensation circuit, and receiving, via the measurement interface, first signal-metric data corresponding to the test signal after propagation through the interconnect under test in the first mode.

The method may furthermore include adjusting, by the controller, the controllable compensation circuit until the first signal-metric data satisfies a reference condition, and determining, by the controller, an inferred loss value representative of loss of the interconnect under test based on an adjusted state of the controllable compensation circuit.

The method may in addition include, in a second mode, routing the test signal through the bypass path, the fixed interconnect, and the interconnect under test while bypassing the controllable compensation circuit, receiving, via the measurement interface, second signal-metric data corresponding to the test signal after propagation through the interconnect under test in the second mode, and determining, by the controller, a de-embedded performance metric of the interconnect under test based on the second signal-metric data and baseline de-embedding data associated with the fixed interconnect.

Other embodiments of this aspect include corresponding computer systems, apparatus, and computer programs recorded on one or more computer storage devices, each configured to perform the actions of the methods.

Implementations may include one or more of the following features.

The method may further include storing compensation calibration data that correlates a plurality of control states of the controllable compensation circuit to a plurality of loss-compensation values, each control state comprising one or more programmable settings of the controllable compensation circuit and each loss-compensation value representing a corresponding amount of channel-loss compensation provided by the controllable compensation circuit. Determining the inferred loss value may comprise matching the adjusted state of the controllable compensation circuit to a corresponding loss-compensation value in the compensation calibration data after the first signal-metric data satisfies the reference condition.

The method may further include establishing the reference condition prior to testing the interconnect under test by routing the test signal through a reference path having a target channel loss, placing the controllable compensation circuit in a known reference state, and measuring a baseline signal-integrity metric. The first signal-metric data and the second signal-metric data may comprise at least one of an eye height, an eye width, a vertical eye closure, a bit-error-rate estimate, or a multi-level signal metric.

The interconnect under test may comprise a plurality of high-speed channels. The method may further include executing the first mode on a specific channel of the plurality of high-speed channels while adjacent channels are in an inactive state to determine a single-channel inferred loss value for the specific channel, executing the first mode on the specific channel while the adjacent channels transmit active signal patterns to determine a multi-channel inferred loss value, and determining a multi-channel impairment value associated with crosstalk by calculating a difference between the single-channel inferred loss value and the multi-channel inferred loss value.

The method may further include generating a quality determination by comparing the inferred loss value against a target loss specification and comparing the de-embedded performance metric against an active eye-mask threshold, aggregating inferred loss values and de-embedded performance metrics across a batch of tested interconnects to compute a statistical process-capability indicator, and issuing a closed-loop control action to upstream manufacturing equipment when the statistical process-capability indicator drops below a predetermined limit.

Implementations of the described techniques may include hardware, a method or process, or a tangible computer-readable medium.

### BRIEF DESCRIPTION OF THE DRAWINGS

Certain features of various embodiments of the present technology are set forth with particularity in the appended claims. A better understanding of the features and advantages of the technology will be obtained by reference to the following detailed description that sets forth illustrative embodiments, in which the principles of the disclosure are utilized, and the accompanying drawings of which:

FIG. 1 illustrates a block diagram of a testing apparatus including a transmitter, a fixed interconnect, a signal-routing circuit having a compensation path and a bypass path, a measurement interface, a controller, and a memory or data store, in accordance with some embodiments.

FIG. 2 illustrates a diagram of establishing a reference condition and obtaining a baseline signal-integrity metric using a reference signal path having a target channel loss, in accordance with some embodiments.

FIG. 3 illustrates a diagram of operating the testing apparatus in a first mode in which a test signal is routed through a compensation path and a controllable compensation circuit is adjusted to determine an inferred loss value of an interconnect under test, in accordance with some embodiments.

FIG. 4 illustrates a diagram of compensation calibration data and multi-channel impairment evaluation based on single-channel and multi-channel inferred loss values, in accordance with some embodiments.

FIG. 5 illustrates a diagram of operating the testing apparatus in a second mode in which the test signal is switched from the compensation path to a bypass path and a de-embedded performance metric is determined using baseline or fixture de-embedding data, in accordance with some embodiments.

FIG. 6 illustrates a flow diagram of generating a quality determination for tested interconnects, computing a statistical process-capability indicator for a batch of tested interconnects, and triggering a closed-loop control action based on the statistical process-capability indicator, in accordance with some embodiments.

FIG. 7 illustrates an example flowchart for testing an interconnect under test, in accordance with some embodiments.

FIG. 8 illustrates a block diagram of an example computer system in which various of the embodiments described herein may be implemented.

### DETAILED DESCRIPTION

In the following description, certain specific details are set forth in order to provide a thorough understanding of various embodiments of the disclosure. However, one skilled in the art will understand that the disclosure may be practiced without these details. Moreover, while various embodiments of the disclosure are disclosed herein, many adaptations and modifications may be made within the scope of the disclosure in accordance with the common general knowledge of those skilled in this art. Such modifications include the substitution of known equivalents for any aspect of the disclosure in order to achieve the same result in substantially the same way.

Unless the context requires otherwise, throughout the present specification and claims, the word “comprise” and variations thereof, such as, “comprises” and “comprising” are to be construed in an open, inclusive sense, that is as “including, but not limited to.” Recitation of numeric ranges of values throughout the specification is intended to serve as a shorthand notation of referring individually to each separate value falling within the range inclusive of the values defining the range, and each separate value is incorporated in the specification as it were individually recited herein. Additionally, the singular forms “a,” “an” and “the” include plural referents unless the context clearly dictates otherwise.

Reference throughout this specification to “one embodiment” or “an embodiment” means that a particular feature, structure or characteristic described in connection with the embodiment is included in at least one embodiment of the present disclosure. Thus, the appearances of the phrases “in one embodiment” or “in an embodiment” in various places throughout this specification are not necessarily all referring to the same embodiment, but may be in some instances. Furthermore, the particular features, structures, or characteristics may be combined in any suitable manner in one or more embodiments.

As used herein, the terms “controller,” “processor,” and similar expressions shall be interpreted in their broadest sense to refer to any hardware circuit or device having the capability of logical judgment, numerical computation, data processing, and/or control signal generation and output. By way of example and not limitation, such a “controller” or “processor” may include, but is not limited to, any of the following forms or any combination thereof: a central processing unit (CPU), a microprocessor (MPU), a microcontroller (MCU), a digital signal processor (DSP), a graphics processing unit (GPU), a tensor processing unit (TPU), an application-specific integrated circuit (ASIC), a complex programmable logic device (CPLD), a field-programmable gate array (FPGA), a system-on-chip (SoC), a neural network processor (NPU), a data processing unit (DPU), or the like. Furthermore, a “controller” or “processor” as used herein may also refer to multiple independent processing cores or programmable logic units integrated within the same chip package, or to multiple cooperating processing modules distributed across different physical chips or boards. It should be understood that any specific device mentioned in this specification is provided merely as an illustrative example to facilitate understanding by those of ordinary skill in the art and does not constitute any limitation on the scope of protection of the present application. In practicing the technical solutions of the present disclosure, those of ordinary skill in the art may select suitable implementation approaches or make equivalent substitutions according to the requirements of specific application scenarios, and all such equivalent implementations fall within the scope of protection of the present application. In some embodiments, a “management controller” refers to a controller that is separate from the host processor and host operating system of a device under test and that may remain accessible for platform-management operations even when the host OS is unavailable, unbooted, or in a fault state. A management controller may include, for example, a Baseboard Management Controller (BMC), a chassis management controller, a satellite management controller, a service processor, or another out-of-band management controller.

With the rapid development of artificial intelligence servers, data centers, and high-performance computing architectures, high-speed interconnect standards such as PCI Express (PCIe) 6.0/7.0, Compute Express Link (CXL), Universal Accelerator Link (UALink), and scale-up and scale-out network architectures have reached transmission rates of 64 GT/s and beyond. Such systems increasingly employ multi-level modulation schemes, such as pulse-amplitude modulation with four levels (PAM4), in which the allowable budget for channel loss and signal-integrity degradation is extremely limited. A high-speed system link may include a transmitting chip, printed circuit board traces, connectors, and a high-speed cable, each of which may contribute insertion loss, reflection, crosstalk, jitter, and other impairments to the overall link. Accurately evaluating the influence of a high-speed cable or other interconnect on the loss and signal integrity of an overall link, while maintaining low cost and high throughput in a real active system environment, has accordingly become an important technical challenge.

Several techniques have been used to test loss and signal integrity of high-speed transmission cables. A first technique uses a vector network analyzer (VNA) to perform passive frequency-domain testing. A VNA can measure S-parameters and obtain high-accuracy insertion-loss and return-loss information; however, VNA-based test equipment is expensive, and a passive measurement environment may not reflect the behavior of a cable in an actual active system driven by a transmitter. When high-density, multi-channel cable assemblies are tested, passive VNA testing can also require substantial time and may be unsuitable for cost-effective mass production. A second technique uses a bit-error-rate tester (BERT) or a high-speed oscilloscope to measure an eye diagram, bit-error rate, or related active signal characteristic. Such testing can use pseudo-random binary sequence (PRBS) patterns or other test patterns to simulate a real high-speed link, but BERT and high-speed oscilloscope test platforms are also expensive. Further, in an active test environment, measured signal degradation may include effects from the cable under test as well as effects from test fixtures, printed circuit board traces, connectors, adapters, and other portions of the test system, making it difficult to separate the independent loss contribution of the cable from fixture and system loss and to obtain standardized data for objective comparison across production lots, suppliers, or cable types. A third technique uses built-in test functions of a chip, such as physical-layer training, equalization, or diagnostic mechanisms. Such mechanisms may allow signal-channel quality to be evaluated within a system; however, these functions are often dependent on proprietary implementations of a particular chip vendor, may lack generality, and may not provide a clear standardized basis for comparison. In addition, scan, training, or adaptation data generated by such internal mechanisms may be difficult to convert into an absolute physical loss value, such as a value expressed in decibels, suitable for objective quality-control inspection.

In view of the foregoing, the embodiments described herein provide a testing apparatus and method that may address one or more of the above-described limitations. The following detailed description describes an architecture capable of operating in a real active signal environment, rapidly estimating loss attributable to a high-speed interconnect while accounting for fixture effects, generating objective signal-performance metrics, and supporting mass-production screening and closed-loop process control.

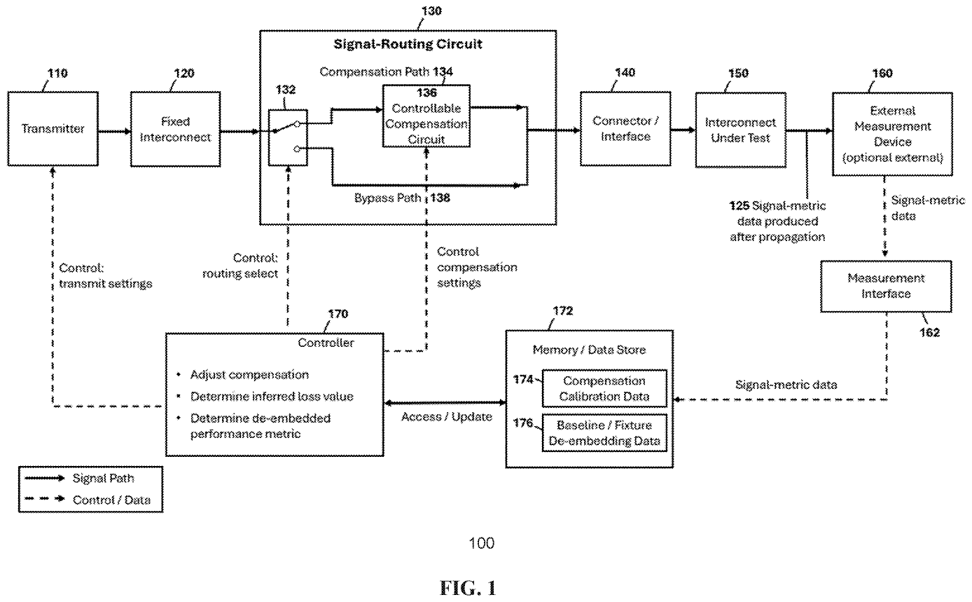

FIG. 1 illustrates a block diagram of a testing apparatus including a transmitter, a fixed interconnect, a signal-routing circuit having a compensation path and a bypass path, a measurement interface, a controller, and a memory or data store, in accordance with some embodiments.

In some embodiments, the testing apparatus illustrated in FIG. 1 is configured to test an interconnect under test in an active signal environment while also reducing or accounting for signal effects contributed by portions of the test apparatus itself. The interconnect under test may be, for example, a cable assembly, a connectorized interconnect, a board-level interconnect, a backplane interconnect, a riser interconnect, or another high-speed signal path (e.g., PCIe cable). The testing apparatus may be used to determine both an inferred loss value of the interconnect under test and a de-embedded performance metric of the interconnect under test. These two determinations are technically distinct and may provide complementary information. The inferred loss value may indicate a loss characteristic of the interconnect under test as derived from compensation behavior in a controlled active signal path, while the de-embedded performance metric may indicate active signal performance of the interconnect under test when a compensation circuit is bypassed and known fixture effects are accounted for.

Multiple measurements may be useful because a single active measurement may not reliably distinguish between loss attributable to the interconnect under test and loss or distortion attributable to a fixture, board trace, connector, switch, or other fixed portion of the testing apparatus. Conversely, a purely passive measurement may not reflect how the interconnect behaves when driven by an actual high-speed transmitter. In some embodiments, the testing apparatus therefore performs a first measurement in a compensation mode to infer loss from an adjusted state of a controllable compensation circuit, and performs a second measurement in a bypass mode to evaluate active signal performance without the controllable compensation circuit masking the behavior of the interconnect under test. This architecture may improve production testing by allowing loss estimation and signal-performance verification to be performed on a common test platform, without requiring physical reconnection of the interconnect under test between measurement modes.

Referring to FIG. 1, a testing apparatus 100 may include a transmitter 110 configured to generate a test signal. The test signal may be a high-speed serial signal. In some embodiments, the test signal may comply with, or be representative of, a communication protocol such as Peripheral Component Interconnect Express (PCIe), Compute Express Link (CXL), Ethernet, InfiniBand, Universal Accelerator Link (UALink), Universal Serial Bus (USB), Thunderbolt, or another present or future high-speed serial communication protocol. In some embodiments, the transmitter 110 may be controlled by a controller 170 to set one or more transmit parameters, such as signal amplitude, pre-emphasis, de-emphasis, data rate, modulation format, pattern type, or other transmit settings.

The transmitter 110 may be coupled to a fixed interconnect 120. The fixed interconnect 120 may include one or more known or characterizable portions of the testing apparatus signal path, such as printed circuit board traces, vias, pads, package interfaces, adapters, fixtures, connectors, or other conductive structures. As used herein, “fixed” indicates that the fixed interconnect 120 is a fixed part of the test apparatus and does not change from test to test. The fixed interconnect 120 may be configured to couple the transmitter 110 to an interconnect under test 150 through a signal-routing circuit 130 and a connector or interface 140. Because the fixed interconnect 120 is part of the test path rather than part of the interconnect under test 150, signal effects of the fixed interconnect 120 may be characterized and stored as baseline or fixture de-embedding data, as described below.

The signal-routing circuit 130 may include an electronic switching element 132, a compensation path 134, a controllable compensation circuit 136 disposed in the compensation path 134, and a bypass path 138. The electronic switching element 132 may selectively route the test signal through either the compensation path 134 or the bypass path 138. In some embodiments, the electronic switching element 132 may comprise a high-speed switch, a multiplexer, a solid-state switch, a transmission gate, or a crosspoint switch. The bypass path 138 may bypass the controllable compensation circuit 136 while still permitting the test signal to propagate through the fixed interconnect 120, the signal-routing circuit 130, the connector or interface 140, and the interconnect under test 150.

The controllable compensation circuit 136 may be configured to compensate for one or more signal impairments in a signal path. In some embodiments, the controllable compensation circuit 136 may include at least one of a redriver, a retimer, a continuous-time linear equalizer, a feed-forward equalizer, a decision-feedback equalizer, a programmable gain circuit, a programmable peaking circuit, or another controllable signal-conditioning circuit. An adjusted state of the controllable compensation circuit 136 may include one or more programmable settings, such as a gain setting, an equalization setting, a peaking setting, a tap-coefficient setting, a filter setting, a timing setting, or a digital register value. A technical purpose of the controllable compensation circuit 136 is not merely to improve the signal for communication, but to provide a controllable and repeatable compensation state from which the controller 170 can infer a loss value representative of the interconnect under test 150.

In some embodiments, the connector or interface 140 is configured to couple the testing apparatus 100 to the interconnect under test 150. The connector or interface 140 may include a cable connector, board connector, socket, receptacle, adapter, interposer, probe interface, or other mechanical or electrical interface. The interconnect under test 150 may include a single high-speed channel or a plurality of high-speed channels. For example, the interconnect under test 150 may include one or more differential pairs, twinax conductors, coaxial conductors, shielded pairs, or other signal conductors.

A measurement device 160 may receive the test signal after propagation through the interconnect under test 150. In some embodiments, the measurement device 160 may be external to the testing apparatus 100. For example, the measurement device 160 may be an oscilloscope, bit-error-rate tester, compliance tester, protocol analyzer, receiver device, receiver card, or other instrument capable of generating signal-metric data from the received test signal. In other embodiments, the measurement device 160 may be integrated into the testing apparatus 100. By allowing the measurement device 160 to be external, the testing apparatus 100 may be supplied as a routing, compensation, calibration, and control architecture that can interface with a user-supplied measurement instrument.

The measurement interface 162 may be configured to receive signal-metric data corresponding to the test signal after propagation through the interconnect under test 150. The measurement interface 162 may include an electrical interface, communication port, instrument-control interface, software interface, data bus, network interface, register interface, or other interface through which signal-metric data is provided to the testing apparatus 100 or to the controller 170. The signal-metric data may include, for example, eye height, eye width, vertical eye closure, jitter information, bit-error-rate information, receiver margin, multi-level eye information, level-separation information, linearity information, or another signal-integrity metric.

The controller 170 may be coupled to the transmitter 110, the signal-routing circuit 130, the controllable compensation circuit 136, the measurement interface 162, and a memory or data store 172. The controller 170 may include a processor, microcontroller, field-programmable gate array, programmable logic device, system-on-chip, embedded controller, test computer, or other control circuitry. The controller 170 may control transmit settings of the transmitter 110, select a signal path of the signal-routing circuit 130, adjust one or more settings of the controllable compensation circuit 136, receive signal-metric data through the measurement interface 162, access calibration and de-embedding data stored in the memory or data store 172, and generate test results for the interconnect under test 150.

The memory or data store 172 may store compensation calibration data 174 and baseline or fixture de-embedding data 176. The compensation calibration data 174 may correlate a plurality of control states of the controllable compensation circuit 136 to a plurality of loss-compensation values. Each control state may include one or more programmable settings of the controllable compensation circuit 136, and each loss-compensation value may represent a corresponding amount of channel-loss compensation provided by the controllable compensation circuit 136. In some embodiments, the compensation calibration data 174 may be stored as a lookup table, calibration curve, transfer-function model, regression model, mathematical function, or other data structure. A technical purpose of the compensation calibration data 174 is to translate an adjusted state of the controllable compensation circuit 136 into a quantitative loss-related value, thereby allowing the controller 170 to determine an inferred loss value without directly measuring passive S-parameters of every interconnect under test.

The baseline or fixture de-embedding data 176 may characterize signal effects associated with the fixed interconnect 120, the connector or interface 140, or other known portions of the testing apparatus 100. In some embodiments, the baseline or fixture de-embedding data 176 may include S-parameters, a transfer function, a loss-versus-frequency table, a time-domain impulse response, a polynomial model, a correction matrix, or another model characterizing signal effects of the fixed interconnect 120. A technical purpose of the baseline or fixture de-embedding data 176 is to account for known loss, reflection, delay, or distortion introduced by fixed portions of the testing apparatus 100, so that a performance metric can more accurately represent the interconnect under test 150.

In a first mode, the controller 170 may cause the test signal to be routed through the compensation path 134, the fixed interconnect 120, and the interconnect under test 150. The controller 170 may adjust the controllable compensation circuit 136 until first signal-metric data received from the measurement interface 162 satisfies a reference condition. The reference condition may be based on a baseline signal-integrity metric, an eye-mask threshold, an eye-opening target, a receiver-margin target, a bit-error-rate target, or another predetermined signal-integrity condition. After the first signal-metric data satisfies the reference condition, the controller 170 may determine an inferred loss value representative of loss of the interconnect under test 150 based on an adjusted state of the controllable compensation circuit 136.

In some embodiments, the controller 170 determines the inferred loss value by matching the adjusted state of the controllable compensation circuit 136 to a corresponding loss-compensation value in the compensation calibration data 174. For example, if the adjusted state includes a register value, gain setting, equalization setting, peaking setting, or tap-coefficient setting, the controller 170 may use the compensation calibration data 174 to identify a loss-compensation value corresponding to that adjusted state. The inferred loss value may be determined from the identified loss-compensation value. In other embodiments, the controller 170 may interpolate between entries of the compensation calibration data 174 or apply a calibration model to the adjusted state.

In a second mode, the controller 170 may cause the test signal to be routed through the bypass path 138, the fixed interconnect 120, and the interconnect under test 150 while bypassing the controllable compensation circuit 136. The electronic switching element 132 may transition the signal-routing circuit 130 between the compensation path 134 and the bypass path 138 without requiring physical disconnection of the interconnect under test 150. This electronic switching may reduce test time, reduce operator-dependent variation, and avoid errors introduced by repeated manual connection and disconnection.

During the second mode, second signal-metric data may be received through the measurement interface 162. The controller 170 may determine a de-embedded performance metric of the interconnect under test 150 based on the second signal-metric data and the baseline or fixture de-embedding data 176. Because the controllable compensation circuit 136 is bypassed in the second mode, the second signal-metric data may reflect active signal behavior of the interconnect under test 150 without compensation from the controllable compensation circuit 136. Applying the baseline or fixture de-embedding data 176 may further reduce or remove the contribution of known fixed portions of the test path.

The first mode and the second mode may therefore provide complementary test information. The first mode may provide an inferred loss value derived from how much compensation is required to satisfy the reference condition. The second mode may provide a de-embedded performance metric derived from an active signal measurement obtained while the controllable compensation circuit 136 is bypassed. In combination, the two modes may provide a more complete assessment of the interconnect under test 150 than either compensation-based loss inference or uncompensated active signal measurement alone.

Although FIG. 1 illustrates certain components as separate blocks, one or more components may be combined, distributed, or implemented differently. For example, the controller 170 and the memory or data store 172 may be integrated in a common processing system, the measurement interface 162 may be implemented as a software interface or instrument-control interface, and the transmitter 110 may be a dedicated signal generator, a protocol transmitter, a SerDes transmitter, a physical-layer transmitter, or another signal source. Similarly, the fixed interconnect 120 may include multiple fixed interconnect portions distributed before, within, or after the signal-routing circuit 130. The illustrated arrangement is therefore an example architecture for implementing compensation-state-based loss estimation and bypass-path de-embedded performance verification.

In some embodiments, the testing apparatus may include an integrated measurement device disposed within the testing apparatus rather than relying on an external measurement instrument. The integrated measurement device may include a receiver circuit, a signal-analysis engine, an eye-scan circuit, a bit-error-rate estimation circuit, or another on-board measurement circuit configured to generate signal-metric data from the test signal after propagation through the interconnect under test. In such an embodiment, the measurement interface may comprise an internal data bus, register interface, or inter-module communication path coupling the integrated measurement device to the controller. By integrating the measurement device, the testing apparatus may operate as a self-contained test platform that does not require connection to an external oscilloscope, bit-error-rate tester, or other laboratory instrument. This may reduce equipment cost, simplify deployment in a production environment, reduce cabling and fixturing between the testing apparatus and an external instrument, and facilitate portable or in-line testing. The controller may perform the first-mode and second-mode operations described herein using signal-metric data received from the integrated measurement device in the same manner as signal-metric data received from an external measurement device. Accordingly, the compensation-based loss-inference procedure and the bypass-path de-embedded performance determination described herein are not limited to configurations in which the measurement device is external to the testing apparatus.

In some embodiments, the testing apparatus may include a plurality of signal-routing circuits, each signal-routing circuit associated with a respective channel or group of channels of a multi-channel interconnect under test. Each signal-routing circuit may include a respective compensation path having a respective controllable compensation circuit and a respective bypass path bypassing the respective controllable compensation circuit. The controller may be configured to operate the plurality of signal-routing circuits concurrently, such that the first mode or the second mode may be executed on multiple channels of the interconnect under test in parallel rather than sequentially. For example, the controller may simultaneously adjust the respective controllable compensation circuits of two or more signal-routing circuits until respective first signal-metric data for each channel satisfies the reference condition, thereby determining respective inferred loss values for the two or more channels concurrently. Similarly, the controller may simultaneously route the test signal through the respective bypass paths of two or more signal-routing circuits to obtain respective second signal-metric data and determine respective de-embedded performance metrics for the two or more channels concurrently. Parallel multi-channel testing may reduce overall test time for high-density, multi-channel interconnects such as multi-lane cable assemblies, thereby improving production throughput. In other embodiments, the controller may operate the plurality of signal-routing circuits in a staggered or pipelined manner, in which different channels are in different stages of the first-mode or second-mode procedure at a given time. The testing apparatus is therefore not limited to sequential per-channel testing and may be scaled to accommodate interconnects having varying channel counts.

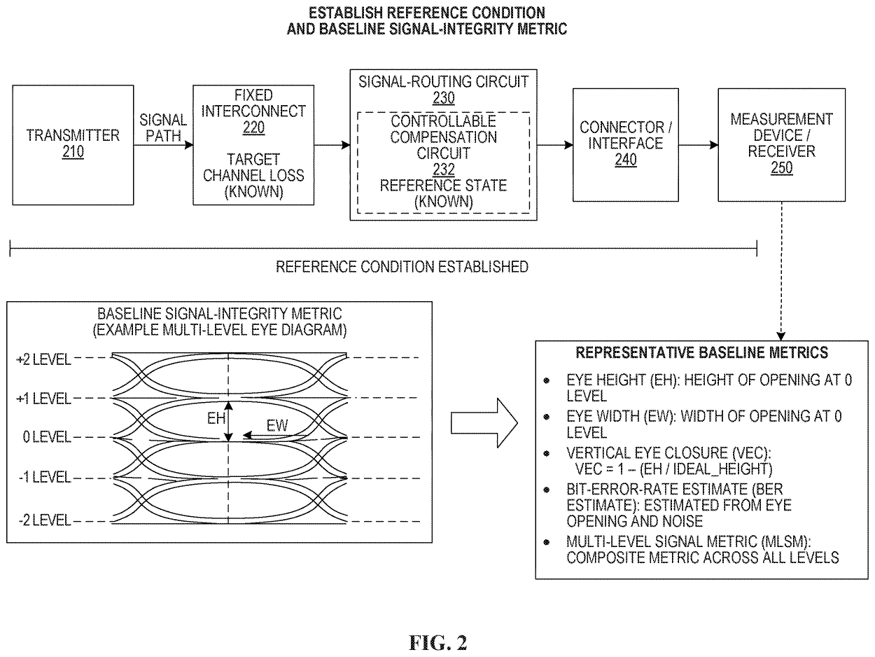

FIG. 2 illustrates a diagram of establishing a reference condition and obtaining a baseline signal-integrity metric using a reference signal path having a target channel loss, in accordance with some embodiments.

In some embodiments, the testing apparatus first establishes a reference condition before testing an interconnect under test. The reference condition provides a repeatable baseline against which later signal-metric data obtained during testing of the interconnect under test can be compared. Establishing the reference condition before testing may reduce sensitivity to fixture variation, board-trace variation, connector variation, and other fixed-path effects of the testing apparatus. In this manner, subsequent compensation adjustments and signal-performance determinations may be referenced to a known active-link condition rather than to an arbitrary or vendor-specific measurement condition.

Referring to FIG. 2, a transmitter 210 generates a test signal and routes the test signal along a reference signal path. The reference signal path may include a fixed interconnect 220, a signal-routing circuit 230, a connector or interface 240, and a measurement device or receiver 250. In some embodiments, the reference signal path is established before an interconnect under test is connected, or before measurement data associated with the interconnect under test is used for pass/fail, loss-estimation, or performance-verification purposes. In other embodiments, a reference fixture, reference load, loopback structure, golden interconnect, or other known structure may be coupled to the connector or interface 240 during reference-condition establishment.

The fixed interconnect 220 may have, or may contribute to, a target channel loss. The target channel loss may correspond to a predetermined loss budget, a protocol-specific channel-loss condition, a system-design loss allocation, a customer-defined loss target, a guard-band condition, or another known channel condition. In some embodiments, the target channel loss may be selected to emulate a limiting or representative operating condition of a high-speed serial link. For example, the target channel loss may correspond to a standardized or design-specific insertion-loss limit for a particular data rate or protocol. The target channel loss need not be limited to any particular numerical value and may vary according to protocol, data rate, modulation format, interconnect type, or test recipe.

During establishment of the reference condition, a controllable compensation circuit 232 of the signal-routing circuit 230 is placed in a known reference state. The known reference state may include a zero-compensation state, a disabled compensation state, a minimum-gain state, a nominal-gain state, a predetermined equalization state, a predetermined peaking state, a predetermined tap-coefficient state, or another stored or repeatable state. In some embodiments, the controllable compensation circuit 232 remains electrically present in the signal path while its compensation function is disabled or set to the known reference state. Thus, placing the controllable compensation circuit 232 in the known reference state does not necessarily require physically removing or bypassing the controllable compensation circuit 232.

The measurement device or receiver 250 receives the test signal after propagation through the reference signal path and obtains baseline signal-metric data. The baseline signal-metric data may be received by a measurement interface of the testing apparatus and may be provided to a controller. The controller may store the baseline signal-metric data as, or derive from the baseline signal-metric data, the reference condition used in later testing. In some embodiments, the reference condition may be represented by one or more threshold values, tolerance bands, eye-mask limits, receiver-margin values, waveform templates, statistical values, or other criteria derived from the baseline signal-metric data.

As shown in FIG. 2, the baseline signal-integrity metric may include a multi-level eye diagram. The illustrated multi-level eye diagram is provided as an example, and other modulation formats may be used. For a multi-level modulated signal, the baseline signal-integrity metric may include measurements corresponding to multiple eye openings or multiple amplitude levels. For a binary or non-return-to-zero signal, the baseline signal-integrity metric may include a single eye opening or one or more corresponding binary-signal metrics. The testing apparatus is therefore not limited to a particular number of eye openings or to a particular modulation format.

In some embodiments, the baseline signal-integrity metric includes an eye height EH and an eye width EW. The eye height EH may indicate a vertical opening or amplitude margin of an eye opening, and the eye width EW may indicate a horizontal opening or timing margin of the eye opening. In additional embodiments, the baseline signal-integrity metric may include vertical eye closure, a bit-error-rate estimate, jitter, receiver margin, level separation, signal linearity, a relative level mismatch value, or another metric representative of signal integrity. For a multi-level signal, the baseline signal-integrity metric may include a composite multi-level signal metric determined across a plurality of eye openings or signal levels.

The reference condition may be determined from one baseline metric or from a combination of baseline metrics. For example, the reference condition may require that a subsequently measured eye height satisfy a baseline-derived eye-height threshold, that a subsequently measured eye width satisfy a baseline-derived eye-width threshold, that a vertical eye closure remain below a baseline-derived limit, that a bit-error-rate estimate remain below a threshold, or that a composite multi-level signal metric satisfy a predetermined relationship with a stored baseline metric. In some embodiments, the predetermined relationship may be equality within tolerance, exceeding a threshold, falling within a tolerance band, satisfying an eye mask, or minimizing an error function relative to a stored baseline waveform or metric vector.

A technical purpose of establishing the reference condition shown in FIG. 2 is to provide a common baseline for later compensation-based loss inference. During a later first mode of operation, the controllable compensation circuit may be adjusted until first signal-metric data obtained from the interconnect under test satisfies the reference condition. Because the reference condition is based on a known reference signal path having a target channel loss and a known compensation state, the adjusted compensation state obtained during the later first mode can be used more reliably to infer a loss value of the interconnect under test.

Another technical purpose of the baseline signal-integrity metric is to support active signal-performance verification in a manner that is not limited to a passive S-parameter measurement. The baseline signal-integrity metric is obtained from an active signal propagated through a real signal path. As a result, the reference condition may account for active transmitter behavior, receiver observation, modulation format, and signal-pattern effects. This allows later measurements of the interconnect under test to be evaluated under conditions that more closely resemble system operation while still preserving a repeatable reference for production testing.

In some embodiments, the same baseline signal-integrity metric, or a reference condition derived from the baseline signal-integrity metric, is used during both compensation-path testing and bypass-path testing. In compensation-path testing, the baseline may be used as a target condition for adjusting the controllable compensation circuit. In bypass-path testing, the baseline or related fixture characterization may be used to interpret second signal-metric data and to determine a de-embedded performance metric. Accordingly, the reference-condition establishment shown in FIG. 2 may provide a common calibration basis for multiple later measurements performed on the interconnect under test.

Although FIG. 2 shows the fixed interconnect 220 as a single block, the fixed interconnect 220 may include multiple fixed structures of the testing apparatus, such as printed circuit board traces, vias, pads, adapters, connectors, sockets, probes, switches, or other known path elements. The target channel loss may be provided by one such structure or by a combination of such structures. In some embodiments, the fixed interconnect 220 and the connector or interface 240 are characterized to generate baseline or fixture de-embedding data used in later processing.

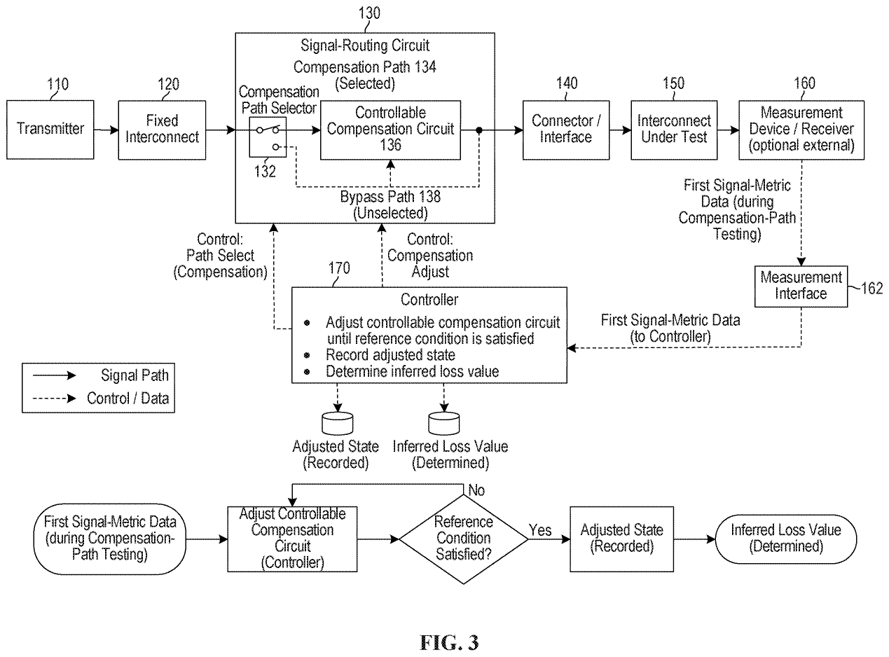

FIG. 3 illustrates a diagram of operating the testing apparatus in a first mode in which a test signal is routed through a compensation path and a controllable compensation circuit is adjusted to determine an inferred loss value of an interconnect under test, in accordance with some embodiments.

In the first mode shown in FIG. 3, the signal-routing circuit 130 selects the compensation path 134 and does not select the bypass path 138. A test signal generated by the transmitter 110 is routed through the fixed interconnect 120, the compensation path 134, the controllable compensation circuit 136, the connector or interface 140, and the interconnect under test 150. After the test signal propagates through the interconnect under test 150, a measurement device or receiver 160 obtains first signal-metric data corresponding to the propagated test signal. The first signal-metric data is provided to the controller 170 through the measurement interface 162.

The first mode may be used to determine how much compensation is needed for the signal path including the interconnect under test 150 to satisfy a reference condition. The reference condition may be established as described with respect to FIG. 2 and may correspond to a baseline signal-integrity metric obtained from a reference path having a known target channel loss. In this manner, the compensation adjustment performed in the first mode is not an open-ended signal-optimization operation, but instead is performed relative to a previously established reference condition. A technical purpose of this operation is to convert a repeatable active-link compensation response into an inferred loss value representative of the interconnect under test 150.

The controller 170 may adjust one or more settings of the controllable compensation circuit 136 while monitoring the first signal-metric data received through the measurement interface 162. The one or more settings may include, for example, a gain setting, an equalization setting, a peaking setting, a tap-coefficient setting, a filter setting, or a digital register value. The controllable compensation circuit 136 may include, for example, a redriver, a retimer, a continuous-time linear equalizer, a feed-forward equalizer, a decision-feedback equalizer, or another controllable compensation circuit. The adjustment may be performed by sweeping settings, stepping through register values, performing a search routine, applying a closed-loop control algorithm, or using another adjustment technique.

As shown in the lower portion of FIG. 3, the controller 170 may determine whether the first signal-metric data satisfies the reference condition. If the reference condition is not satisfied, the controller 170 continues adjusting the controllable compensation circuit 136. If the reference condition is satisfied, the controller 170 records an adjusted state of the controllable compensation circuit 136. The adjusted state may correspond to one setting or to a combination of settings of the controllable compensation circuit 136. In some embodiments, satisfying the reference condition may mean that the first signal-metric data equals or approximates a baseline metric within a tolerance, exceeds a threshold, satisfies an eye mask, satisfies a receiver-margin requirement, satisfies a bit-error-rate estimate, or satisfies a composite signal-integrity criterion.

After the adjusted state is recorded, the controller 170 determines an inferred loss value for the interconnect under test 150. In some embodiments, the inferred loss value is determined based on the adjusted state of the controllable compensation circuit 136. For example, the controller 170 may use compensation calibration data that correlates control states of the controllable compensation circuit 136 with corresponding loss-compensation values. The controller 170 may match the adjusted state to a corresponding loss-compensation value in the compensation calibration data. In other embodiments, the controller 170 may interpolate between calibration entries, apply a transfer-function model, or apply another calibration relationship to determine the inferred loss value.

The inferred loss value determined in the first mode may represent an insertion-loss-related value, an equivalent channel-loss value, or another loss metric attributable to the interconnect under test 150 under the test condition. The inferred loss value is “inferred” in the sense that it is derived from the compensation state required to satisfy the reference condition, rather than being obtained solely by directly measuring passive S-parameters of the interconnect under test during production. This may reduce dependence on expensive passive measurement equipment while still providing a quantitative loss-related metric suitable for comparison, screening, or quality control.

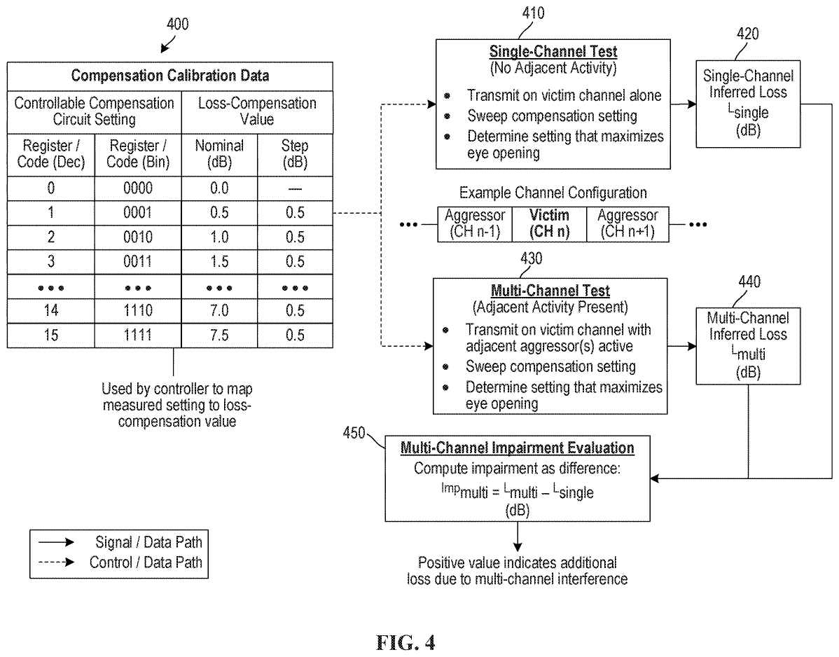

In some embodiments, the first mode shown in FIG. 3 may be performed for a selected high-speed channel of a multi-channel interconnect under test 150. The selected channel may be tested while one or more adjacent channels are inactive, terminated, or otherwise maintained in a predetermined quiet state. In such an implementation, the inferred loss value determined from the adjusted state of the controllable compensation circuit 136 may be used as a single-channel inferred loss value for the selected channel. The same first-mode procedure may also be repeated under other channel-activity conditions, as described with respect to FIG. 4, to evaluate additional impairment caused by simultaneous operation of multiple channels.

Because the first signal-metric data may be obtained from a measurement device or receiver 160 that is external to the testing apparatus, the first mode can be implemented with different measurement instruments while preserving the same compensation-path architecture and controller logic. For example, the measurement device or receiver 160 may be a receiver, oscilloscope, bit-error-rate tester, compliance tester, protocol receiver, or another instrument capable of producing signal-metric data. The measurement interface 162 allows the controller 170 to receive the resulting metric data and perform the compensation adjustment and loss-inference procedure without requiring the measurement device or receiver 160 to be integrated into the testing apparatus.

A technical improvement provided by the first mode is that the testing apparatus can use an active high-speed signal environment to obtain a quantitative loss-related value of the interconnect under test 150. The interconnect under test 150 is evaluated while connected in a real signal path that includes a transmitter, fixed interconnect, routing circuitry, and measurement device or receiver. At the same time, the loss value is not merely an unprocessed active eye result, because the controller 170 derives the value from a controlled compensation adjustment relative to a reference condition. This combination can provide a production-suitable bridge between active signal testing and loss-based quality characterization.

FIG. 4 illustrates a diagram of compensation calibration data and multi-channel impairment evaluation based on single-channel and multi-channel inferred loss values, in accordance with some embodiments.

Referring to FIG. 4, compensation calibration data 400 may be stored in a memory or data store accessible by the controller. The compensation calibration data 400 may correlate control states of a controllable compensation circuit to corresponding loss-compensation values. In the illustrated example, the control states include register or code values, including decimal and binary code representations, and the loss-compensation values include nominal compensation values and step values expressed in decibels. The table shown in FIG. 4 is only one example. In other embodiments, the compensation calibration data 400 may include gain settings, equalization settings, peaking settings, tap coefficients, filter coefficients, digital register values, analog bias values, mode settings, or any combination thereof.

In some embodiments, each control state in the compensation calibration data 400 represents one or more programmable settings of the controllable compensation circuit, and each corresponding loss-compensation value represents an amount of channel-loss compensation provided by the controllable compensation circuit when operated in that control state. The compensation calibration data 400 may be generated during manufacture, during system calibration, from vendor-supplied characterization data, from known-loss calibration structures, from standard inter-symbol-interference boards, from empirical measurements, or from a combination of such sources. The compensation calibration data 400 may be stored as a lookup table, calibration curve, transfer-function model, regression model, interpolation model, or other mapping relationship.

After the first signal-metric data satisfies a reference condition as described with respect to FIG. 3, the controller may use the compensation calibration data 400 to determine an inferred loss value. For example, the controller may match the adjusted state of the controllable compensation circuit to a corresponding entry in the compensation calibration data 400. If the adjusted state falls between stored entries, the controller may interpolate between two or more entries, apply a curve-fit model, or otherwise determine a corresponding loss-compensation value. The inferred loss value may then be determined from the matched or interpolated loss-compensation value.

The compensation calibration data 400 allows a signal-conditioning response to be used as a quantitative loss-estimation mechanism. Instead of merely reporting that the controllable compensation circuit was adjusted, the controller can translate the adjusted state into a loss-compensation value that is usable as an inferred loss value or as an input to an inferred loss calculation. This provides a technical mechanism for converting active-link compensation behavior into a physical or quasi-physical loss-related metric that can be compared across units, lots, channels, or suppliers.

FIG. 4 also illustrates evaluation of a multi-channel interconnect under test. The interconnect under test may include a plurality of high-speed channels. A selected channel may be referred to as a victim channel, and one or more adjacent channels may be referred to as aggressor channels. The terms “victim” and “aggressor” are used for convenience to describe relative channel activity during a test and do not require a permanent functional distinction among the channels. A given channel may be tested as a selected channel in one test and may operate as an adjacent channel in another test.

In a single-channel test 410, the selected or victim channel is tested while adjacent channels are inactive, quiet, terminated, or otherwise placed in a predetermined non-aggressing state. The controller may execute the first mode on the selected channel, adjust the controllable compensation circuit, and use the compensation calibration data 400 to determine a single-channel inferred loss value 420, shown as L_{single}. The single-channel inferred loss value 420 may represent a loss-related metric for the selected channel under a condition in which adjacent-channel activity is absent or controlled.

In a multi-channel test 430, the selected channel is tested while one or more adjacent channels transmit active signal patterns. The active signal patterns may include pseudo-random binary sequences, compliance test patterns, stress patterns, protocol traffic patterns, idle patterns, training patterns, or other signal patterns suitable for stressing or representing simultaneous operation of the plurality of high-speed channels. During the multi-channel test 430, the controller may again execute the first mode on the selected channel, adjust the controllable compensation circuit, and use the compensation calibration data 400 to determine a multi-channel inferred loss value 440, shown as Lₘᵤₗₜᵢ.

The multi-channel inferred loss value 440 may differ from the single-channel inferred loss value 420 because simultaneous operation of adjacent channels may introduce additional signal impairment. Such impairment may include near-end crosstalk, far-end crosstalk, inter-pair coupling, common-mode conversion, reflection-related impairment, shielding-related degradation, or other multi-channel effects. In some embodiments, the adjacent channels may be driven at the same data rate as the selected channel. In other embodiments, the adjacent channels may be driven using a different data rate, pattern, phase relationship, amplitude, modulation format, or activity condition to evaluate different stress scenarios.

A multi-channel impairment evaluation 450 may be performed by comparing the single-channel inferred loss value 420 and the multi-channel inferred loss value 440. In the illustrated example, a multi-channel impairment value Impₘᵤₗₜᵢ is computed as a difference between Lₘᵤₗₜᵢ and L_{single}. A positive difference may indicate additional loss, margin reduction, or compensation requirement caused by simultaneous operation of multiple channels of the interconnect under test. In other embodiments, the multi-channel impairment value may be computed as a ratio, percentage change, normalized margin difference, eye-opening reduction, additional compensation step count, or another comparative metric.

The multi-channel impairment value may be associated with crosstalk, but is not limited to crosstalk alone unless specifically stated. Because the metric is based on a difference between inferred loss values obtained under different channel-activity conditions, it may capture combined impairment from crosstalk and other channel-interaction effects. In some embodiments, the multi-channel impairment value may be used to identify interconnects that satisfy a single-channel loss requirement but exhibit unacceptable degradation under realistic multi-lane operating conditions.

The procedure illustrated in FIG. 4 may be repeated across multiple channels of the interconnect under test. For example, each channel may be tested as the selected channel while one or more neighboring channels are inactive and then active. The resulting single-channel inferred loss values, multi-channel inferred loss values, and multi-channel impairment values may be stored per channel and used for pass/fail classification, binning, statistical analysis, or process-control operations.

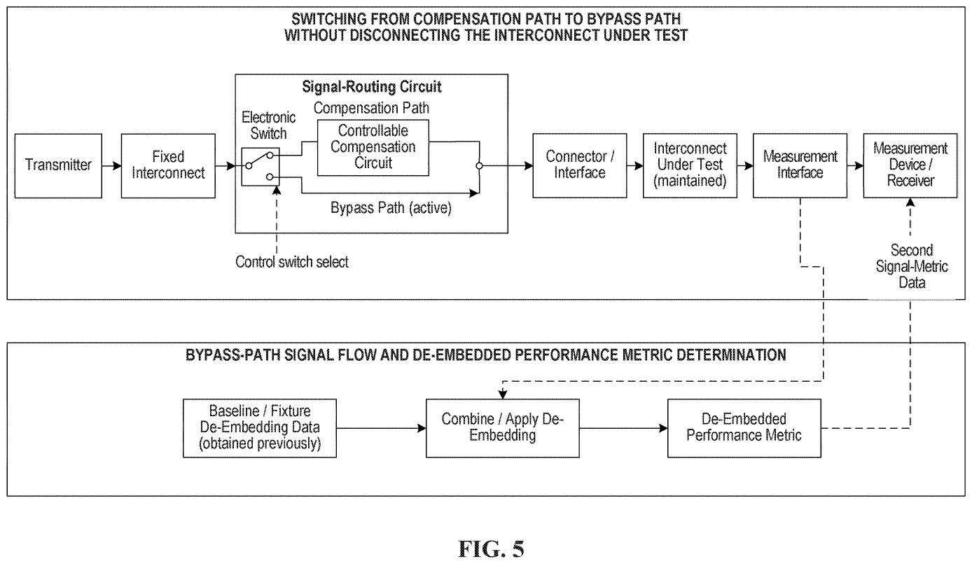

FIG. 5 illustrates a diagram of operating the testing apparatus in a second mode in which the test signal is switched from the compensation path to a bypass path and a de-embedded performance metric is determined using baseline or fixture de-embedding data, in accordance with some embodiments.

The second mode shown in FIG. 5 may be performed after (or before) the first-mode compensation-path operation described with respect to FIG. 3. In the first mode, the controllable compensation circuit is used to determine an inferred loss value based on an adjusted compensation state. In the second mode, the controllable compensation circuit is bypassed so that the interconnect under test can be evaluated using signal-metric data that is not corrected or masked by the controllable compensation circuit. The second mode therefore provides an active signal-performance view of the interconnect under test that complements the inferred loss value obtained in the first mode.

Referring to the upper portion of FIG. 5, an electronic switch of the signal-routing circuit transitions the test signal from the compensation path to the bypass path. The transition may be performed under control of a controller, for example by issuing a routing-select command to the electronic switch. The electronic switch may be the same as, or may correspond to, the switching element 132 described with respect to FIG. 1. The bypass path is shown as active, and the compensation path is not selected. As a result, the test signal bypasses the controllable compensation circuit while the interconnect under test remains connected to the connector or interface.

In some embodiments, the transition from the compensation path to the bypass path is performed without physically disconnecting the interconnect under test from the testing apparatus. This may reduce test time, reduce connector wear, reduce operator-dependent variation, and avoid measurement variation caused by repeated unplugging and re-plugging. The same physical placement and connection condition of the interconnect under test may therefore be maintained between the first-mode loss-inference operation and the second-mode active performance measurement.

Referring to the lower portion of FIG. 5, second signal-metric data obtained during the bypass-path operation is used together with baseline or fixture de-embedding data to determine a de-embedded performance metric. The lower portion of FIG. 5 illustrates the data-processing relationship rather than a second physical signal path. In particular, the second signal-metric data obtained from the measurement device or receiver may be provided to a de-embedding operation, and baseline or fixture de-embedding data obtained previously may also be provided to the de-embedding operation. The de-embedding operation may combine, correct, normalize, subtract, transform, or otherwise process the second signal-metric data using the baseline or fixture de-embedding data.

During the second mode, the measurement device or receiver obtains second signal-metric data corresponding to the test signal after propagation through the interconnect under test while the bypass path is active. The second signal-metric data may be provided to the controller through the measurement interface. The second signal-metric data may include any suitable active signal-performance metric, including eye height, eye width, vertical eye closure, jitter, receiver margin, level separation, linearity, bit-error-rate estimate, eye-mask information, waveform information, or another signal-integrity metric.

The baseline or fixture de-embedding data may have been obtained previously, for example during calibration of the testing apparatus. The baseline or fixture de-embedding data may characterize signal effects of the fixed interconnect, the connector or interface, the signal-routing circuit, the measurement path, or other known portions of the testing apparatus signal path. In some embodiments, the baseline or fixture de-embedding data may include S-parameters, a transfer function, a loss-versus-frequency table, a time-domain impulse response, a polynomial model, a correction matrix, or another model or correction relationship.

The de-embedded performance metric may represent a signal-performance characteristic of the interconnect under test after known fixture or baseline effects are removed, compensated, normalized, or otherwise accounted for. In some embodiments, de-embedding may include subtracting a known loss value, applying a frequency-domain correction, applying an inverse transfer function, applying a time-domain correction, applying a matrix correction, normalizing a measured eye opening, or applying another mathematical operation based on the baseline or fixture de-embedding data. The de-embedded performance metric may therefore be more directly attributable to the interconnect under test than raw second signal-metric data alone.

The technical purpose of the second mode is different from the technical purpose of the first mode. The first mode uses a controllable compensation circuit as a calibrated inference mechanism for estimating loss. The second mode bypasses that controllable compensation circuit to obtain an active performance metric under an uncompensated or less-compensated condition, while still accounting for known fixture effects. Thus, the second mode can reveal performance degradation that may be obscured if the controllable compensation circuit remains active, such as insufficient eye opening, excessive jitter, level-separation degradation, nonlinearity, or other signal-integrity impairment.

In some embodiments, the second mode may be performed immediately after the first mode, or after completion of a selected number of first-mode operations. For example, the testing apparatus may first determine an inferred loss value for one or more channels and then switch to the bypass path to determine one or more de-embedded performance metrics. In other embodiments, the testing apparatus may alternate between the first mode and the second mode for each channel or for each interconnect under test. The switching operation shown in FIG. 5 permits such mode changes to occur without reconfiguring or physically reconnecting the interconnect under test.

The de-embedded performance metric determined in the second mode may be stored, displayed, compared with a threshold, used for pass/fail determination, used for binning, or used as an input to batch-level statistical analysis. For example, the de-embedded performance metric may be compared with an active eye-mask threshold, a minimum eye-height threshold, a minimum eye-width threshold, a receiver-margin threshold, or another signal-performance specification.

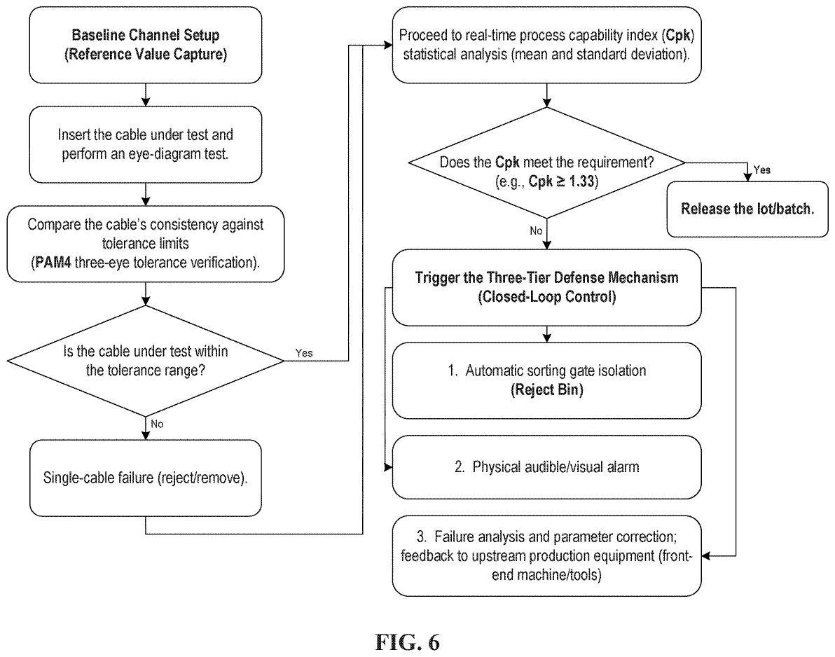

FIG. 6 illustrates a flow diagram of generating a quality determination for tested interconnects, computing a statistical process-capability indicator for a batch of tested interconnects, and triggering a closed-loop control action based on the statistical process-capability indicator, in accordance with some embodiments.

The operations shown in FIG. 6 may be performed after, or in combination with, the first-mode and second-mode operations described above. For an individual interconnect under test, the testing apparatus may obtain an inferred loss value and a de-embedded performance metric. The inferred loss value may be determined from a compensation-path operation, and the de-embedded performance metric may be determined from a bypass-path operation using baseline or fixture de-embedding data. These values may be used together to determine whether the individual interconnect satisfies one or more quality requirements.

In some embodiments, the testing apparatus performs a baseline channel setup or reference value capture before evaluating production units. The baseline channel setup may include establishing a reference condition and obtaining a baseline signal-integrity metric, as described with respect to FIG. 2. After the baseline channel setup is completed, an interconnect under test may be inserted or otherwise coupled to the testing apparatus, and the testing apparatus may obtain signal-metric data for the interconnect under test. Although FIG. 6 refers to a cable under test and an eye-diagram test, the same operations may be applied to any suitable interconnect under test and to any suitable signal-metric data, including eye-diagram data, receiver-margin data, bit-error-rate data, waveform data, or other signal-integrity data.

The controller may generate a per-unit quality determination by comparing the inferred loss value against a target loss specification and comparing the de-embedded performance metric against an active signal-performance threshold. In some embodiments, the active signal-performance threshold may include an active eye-mask threshold, a minimum eye-height threshold, a minimum eye-width threshold, a vertical eye-closure threshold, a bit-error-rate threshold, or another performance threshold. For a multi-level signal, the threshold may include a tolerance requirement for multiple eye openings or multiple signal levels. For a binary signal, the threshold may include a tolerance requirement for a single eye opening or another binary-signal metric.

Based on the comparisons, the interconnect under test may be classified as passing, failing, or belonging to a predetermined quality bin. In some embodiments, a unit that does not satisfy one or more per-unit requirements may be rejected, removed from a production flow, routed to a rework station, or assigned to a lower quality bin. In other embodiments, a unit satisfying a primary requirement but not satisfying a higher-grade requirement may be assigned to an intermediate quality bin. The per-unit quality determination may be stored with a unit identifier, batch identifier, channel identifier, test recipe identifier, timestamp, or other traceability information.

As shown in FIG. 6, the testing apparatus may also perform batch-level statistical analysis. The controller may aggregate inferred loss values, de-embedded performance metrics, or both across a batch of tested interconnects. A batch may correspond to a production lot, work order, reel, supplier lot, manufacturing shift, product family, or another grouping of tested units. The controller may compute a statistical process-capability indicator based on a distribution of at least one selected quality characteristic of the batch relative to one or more specification limits.

In some embodiments, the statistical process-capability indicator includes a Cpk value. The Cpk value may be computed using a mean and standard deviation of a selected quality characteristic and one or more specification limits. The selected quality characteristic may include an inferred loss value, an eye-height value, an eye-width value, a de-embedded performance metric, a multi-channel impairment value, or another metric generated by the testing apparatus. Other statistical indicators may also be used, such as Cp, Pp, Ppk, yield percentage, standard deviation, range, moving range, or another process-control metric.

The controller may compare the statistical process-capability indicator with a predetermined limit. If the statistical process-capability indicator satisfies the predetermined limit, the batch may be released, production may continue, or monitoring may continue. If the statistical process-capability indicator does not satisfy the predetermined limit, the controller may issue or cause issuance of a closed-loop control action. The predetermined limit may be, for example, a Cpk threshold such as 1.33, or another threshold selected based on customer requirements, product class, process maturity, or manufacturing-control policy.

The closed-loop control action may include one or more of generating an alarm, causing sorting or isolation of a tested interconnect, stopping or pausing a production process, or transmitting a correction parameter to upstream manufacturing equipment. For example, the testing apparatus may activate an audible or visual alarm, command a sorting gate to direct failed or suspect units to a reject bin, place a production line on hold, notify an operator or manufacturing execution system, or send correction information to a front-end machine or tool.

The correction parameter transmitted to upstream manufacturing equipment may be based on the type of metric that failed or drifted. For example, an increase in inferred loss may be associated with conductor, dielectric, length, plating, or termination conditions. A decrease in a de-embedded eye-height or eye-width metric may be associated with signal integrity degradation, impedance discontinuity, excessive jitter, or other physical variations. An increase in multi-channel impairment may be associated with shielding, spacing, pair-to-pair coupling, or crosstalk-related manufacturing conditions. The testing apparatus may therefore convert measured or inferred electrical metrics into production feedback useful for correcting a process condition.

As used herein, “upstream manufacturing equipment” refers to production machinery or tooling responsible for physically fabricating, processing, or assembling the interconnects or components thereof, and that operates at a stage in the production flow that precedes the testing apparatus. By way of example and not limitation, upstream manufacturing equipment may include machines or tools that control conductor formation, dielectric application, plating thickness, termination processing, shielding application, conductor spacing, or other physical manufacturing parameters. Such equipment is considered “upstream” because it operates earlier in the manufacturing process relative to the point at which the interconnects reach the testing apparatus for electrical evaluation.

In some embodiments, per-unit quality determination and batch-level process-capability analysis are performed together. A single failed unit may be rejected or isolated, while the remaining batch data may continue to be accumulated for statistical analysis. Conversely, even if individual units satisfy per-unit limits, a trend or distribution in the batch data may cause the statistical process-capability indicator to fall below a predetermined limit, resulting in a closed-loop control action. This allows the testing apparatus to support both individual product screening and process-level monitoring.

The operations illustrated in FIG. 6 may be implemented by the controller of the testing apparatus, by an external computer coupled to the testing apparatus, by a manufacturing execution system, or by a combination of such components. The quality-control output may be stored, displayed, transmitted to factory equipment, or used to update a test recipe. In this manner, the testing apparatus may link active electrical test results with manufacturing control, thereby supporting high-throughput screening and closed-loop process improvement for high-speed interconnect production.

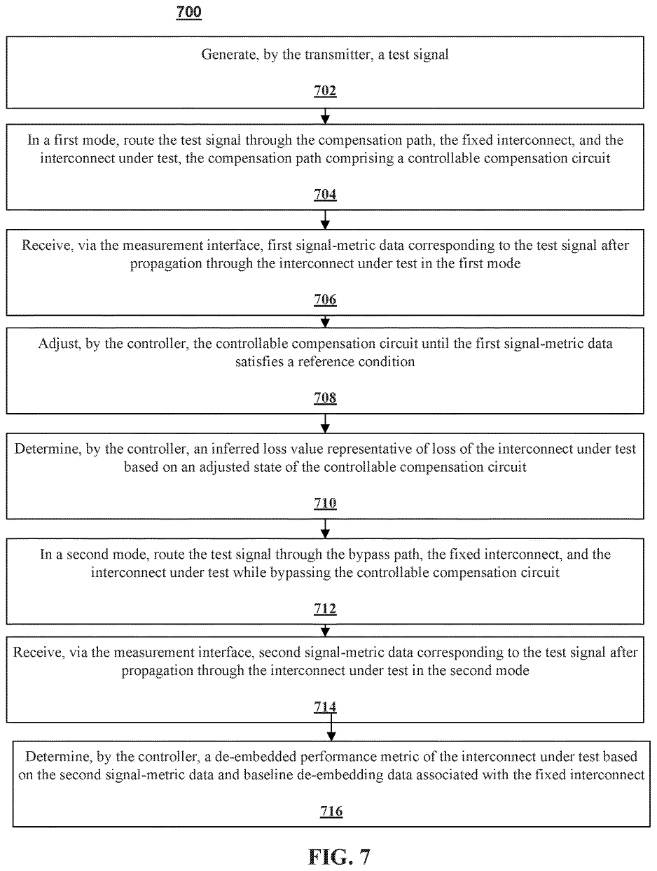

FIG. 7 illustrates an example flowchart for testing an interconnect under test, in accordance with some embodiments. In some implementations, one or more process blocks of FIG. 7 may be performed by a device.

As shown in FIG. 7, process 700 may include generating, by the transmitter, a test signal (block 702). For example, the device may generate, by the transmitter, a test signal, as described above. As also shown in FIG. 7, process 700 may include, in a first mode, routing the test signal through the compensation path, the fixed interconnect, and the interconnect under test, the compensation path including a controllable compensation circuit (block 704). For example, the device may, in the first mode, route the test signal through the compensation path, the fixed interconnect, and the interconnect under test, the compensation path having a controllable compensation circuit, as described above. As further shown in FIG. 7, process 700 may include receiving, via the measurement interface, first signal-metric data corresponding to the test signal after propagation through the interconnect under test in the first mode (block 706). For example, the device may receive, via the measurement interface, first signal-metric data corresponding to the test signal after propagation through the interconnect under test in the first mode, as described above. As also shown in FIG. 7, process 700 may include adjusting, by the controller, the controllable compensation circuit until the first signal-metric data satisfies a reference condition (block 708). For example, the device may adjust, by the controller, the controllable compensation circuit until the first signal-metric data satisfies a reference condition, as described above. As further shown in FIG. 7, process 700 may include determining, by the controller, an inferred loss value representative of loss of the interconnect under test based on an adjusted state of the controllable compensation circuit (block 710). For example, the device may determine, by the controller, an inferred loss value representative of loss of the interconnect under test based on an adjusted state of the controllable compensation circuit, as described above. As also shown in FIG. 7, process 700 may include, in a second mode, routing the test signal through the bypass path, the fixed interconnect, and the interconnect under test while bypassing the controllable compensation circuit (block 712). For example, the device may, in the second mode, route the test signal through the bypass path, the fixed interconnect, and the interconnect under test while bypassing the controllable compensation circuit, as described above. As further shown in FIG. 7, process 700 may include receiving, via the measurement interface, second signal-metric data corresponding to the test signal after propagation through the interconnect under test in the second mode (block 714). For example, the device may receive, via the measurement interface, second signal-metric data corresponding to the test signal after propagation through the interconnect under test in the second mode, as described above. As also shown in FIG. 7, process 700 may include determining, by the controller, a de-embedded performance metric of the interconnect under test based on the second signal-metric data and baseline de-embedding data associated with the fixed interconnect (block 716). For example, the device may determine, by the controller, a de-embedded performance metric of the interconnect under test based on the second signal-metric data and baseline de-embedding data associated with the fixed interconnect, as described above.

In a first implementation, process 700 further includes storing compensation calibration data that correlates a plurality of control states of the controllable compensation circuit to a plurality of loss-compensation values, each control state having one or more programmable settings of the controllable compensation circuit and each loss-compensation value representing a corresponding amount of channel-loss compensation provided by the controllable compensation circuit, where determining the inferred loss value may include matching the adjusted state of the controllable compensation circuit to a corresponding loss-compensation value in the compensation calibration data after the first signal-metric data satisfies the reference condition.

In a second implementation, alone or in combination with the first implementation, process 700 may include establishing the reference condition prior to testing the interconnect under test by: routing the test signal through a reference path having a target channel loss, placing the controllable compensation circuit in a known reference state, and measuring a baseline signal-integrity metric, where the first signal-metric data and the second signal-metric data may include at least one of an eye height, an eye width, a vertical eye closure, a bit-error-rate estimate, or a multi-level signal metric.

In a third implementation, alone or in combination with the first and second implementations, the interconnect under test may include a plurality of high-speed channels, the method further includes executing the first mode on a specific channel of the plurality of high-speed channels while adjacent channels are in an inactive state to determine a single-channel inferred loss value for the specific channel, executing the first mode on the specific channel while the adjacent channels transmit active signal patterns to determine a multi-channel inferred loss value, and determining a multi-channel impairment value associated with crosstalk by calculating a difference between the single-channel inferred loss value and the multi-channel inferred loss value.

In a fourth implementation, alone or in combination with one or more of the first through third implementations, process 700 may include generating a quality determination by: comparing the inferred loss value against a target loss specification and comparing the de-embedded performance metric against an active eye-mask threshold, aggregating inferred loss values and de-embedded performance metrics across a batch of tested interconnects to compute a statistical process-capability indicator, and issuing a closed-loop control action to upstream manufacturing equipment when the statistical process-capability indicator drops below a predetermined limit.

Although FIG. 7 shows example blocks of process 700, in some implementations, process 700 may include additional blocks, fewer blocks, different blocks, or differently arranged blocks than those depicted in FIG. 7. Additionally, or alternatively, two or more of the blocks of process 700 may be performed in parallel.

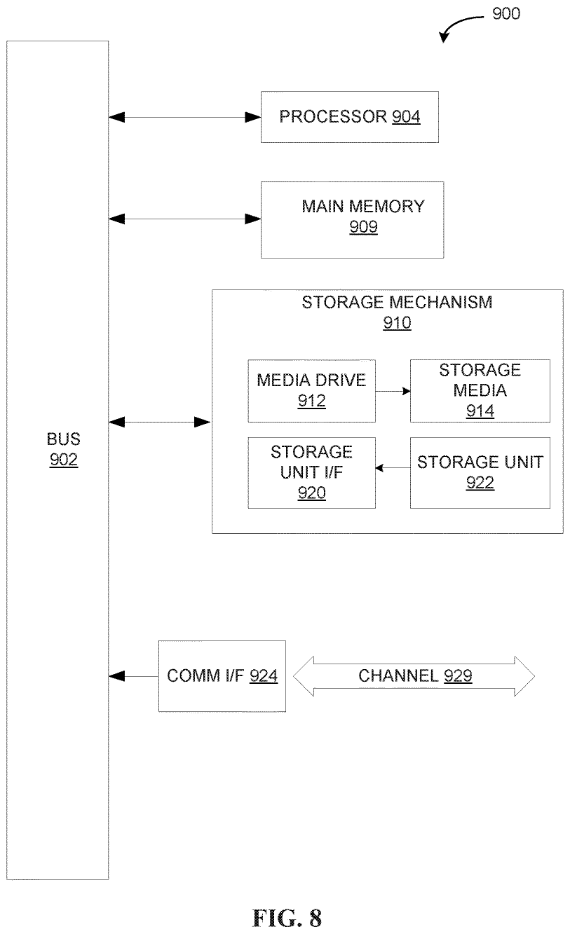

FIG. 8 illustrates a block diagram of an example computer system in which various of the embodiments described herein may be implemented.

As used herein, the term module may describe a given unit of functionality that can be performed in accordance with one or more embodiments of the present application. As used herein, a module may be implemented utilizing any form of hardware, software, or a combination thereof. For example, one or more processors, controllers, ASICs, PLAs, PALs, CPLDs, FPGAs, logical components, software routines or other mechanisms may be implemented to make up a module. In implementation, the various modules described herein may be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the application are implemented in whole or in part using software, in one embodiment, these software elements can be implemented to operate with a computing or processing module capable of carrying out the functionality described with respect thereto. One such example computing module is shown in FIG. 8. Various embodiments are described in terms of this example-computing module 900. After reading this description, it will become apparent to a person skilled in the relevant art how to implement the application using other computing modules or architectures.

Referring now to FIG. 8, computing module 900 may represent, for example, computing or processing capabilities found within desktop, laptop, notebook, tablet, cloud and edge, computers; hand-held computing devices (tablets, PDA's, smart phones, cell phones, palmtops, etc.); mainframes, supercomputers, workstations or servers; or any other type of special-purpose or general-purpose computing devices as may be desirable or appropriate for a given application or environment. Computing module 900 may also represent computing capabilities embedded within or otherwise available to a given device. For example, a computing module may be found in other electronic devices such as, for example, digital cameras, navigation systems, cellular telephones, portable computing devices, modems, routers, WAPs, terminals and other electronic devices that may include some form of processing capability.

Computing module 900 may include, for example, one or more processors, controllers, control modules, or other processing devices, such as a processor 904. Processor 904 may be implemented using a general-purpose or special-purpose processing engine such as, for example, a microprocessor, controller, or other control logic. In the illustrated example, processor 904 is connected to a bus 902, although any communication medium can be used to facilitate interaction with other components of computing module 900 or to communicate externally. The bus 902 may also be connected to other components such as a display, input devices, or cursor control to facilitate interaction and communications between the processor and/or other components of the computing module 900.

Computing module 900 may also include one or more memory modules, simply referred to herein as main memory 909. For example, random-access memory (RAM) or other dynamic memory may be used for storing information and instructions to be executed by processor 904. Main memory 909 may also be used for storing temporary variables or other intermediate information during execution of instructions to be executed by processor 904. Computing module 900 may likewise include a read only memory (“ROM”) or other static storage device 910 coupled to bus 902 for storing static information and instructions for processor 904.

Computing module 900 may also include one or more various forms of information storage devices 910, which may include, for example, a media drive 912 and a storage unit interface 920. The media drive 912 may include a drive or other mechanism to support fixed or removable storage media 914. For example, a hard disk drive, a floppy disk drive, a magnetic tape drive, an optical disk drive, a CD, DVD or Bluray drive (R or RW), or other removable or fixed media drive 912 may be provided. Accordingly, storage media 914 may include, for example, a hard disk, a floppy disk, magnetic tape, cartridge, optical disk, a CD or DVD, or other fixed or removable medium that is read by, written to or accessed by media drive 912. As these examples illustrate, the storage media 914 can include a computer usable storage medium having stored therein computer software or data.

In alternative embodiments, information storage devices 910 may include other similar instrumentalities for allowing computer programs or other instructions or data to be loaded into computing module 900. Such instrumentalities may include, for example, a fixed or removable storage unit 922 and a storage unit interface 920. Examples of such storage units and storage unit interfaces can include a program cartridge and cartridge interface, a removable memory (for example, a flash memory or other removable memory module) and memory slot, a PCMCIA slot and card, and other fixed or removable storage units and interfaces that allow software and data to be transferred from the storage unit to computing module 900.

Computing module 900 may also include a communications interface (comm I/F) 924 or network interface(s). Communications or network interface(s) 924 may be used to allow software and data to be transferred between computing module 900 and external devices. Examples of communications interface or network interface(s) may include a modem or soft modem, a network interface (such as an Ethernet, network interface card, WiMedia, WiFi, IEEE 802.XX or other interface), a communications port (such as for example, a USB port, IR port, RS232 port Bluetooth® interface, or other port), or other communications interface. Software and data transferred via communications or network interface(s) may typically be carried on signals, which can be electronic, electromagnetic (which includes optical) or other signals capable of being exchanged by a given communications interface. These signals may be provided to communications interface via a channel 929. This channel may carry signals and may be implemented using a wired or wireless communication medium. Some examples of a channel may include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media such as, for example, memory 909, ROM, and storage unit interface 920. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions may enable the computing module 900 to perform features or functions of the present application as discussed herein.

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Each process, method, and algorithm described in the preceding sections may be embodied in, and fully or partially automated by, code modules executed by one or more computer systems or computer processors comprising computer hardware. The processes and algorithms may be implemented partially or wholly in application-specific circuitry.

When the functions disclosed herein are implemented in the form of software functional units and sold or used as independent products, they can be stored in a processor executable non-volatile computer readable storage medium. Particular technical solutions disclosed herein (in whole or in part) or aspects that contribute to current technologies may be embodied in the form of a software product. The software product may be stored in a storage medium, comprising a number of instructions to cause a computing device (which may be a personal computer, a server, a network device, and the like) to execute all or some steps of the methods of the embodiments of the present application. The storage medium may comprise a flash drive, a portable hard drive, ROM, RAM, a magnetic disk, an optical disc, another medium operable to store program code, or any combination thereof.

Particular embodiments further provide a system comprising a processor and a non-transitory computer-readable storage medium storing instructions executable by the processor to cause the system to perform operations corresponding to steps in any method of the embodiments disclosed above. Particular embodiments further provide a non-transitory computer-readable storage medium configured with instructions executable by one or more processors to cause the one or more processors to perform operations corresponding to steps in any method of the embodiments disclosed above.

Embodiments disclosed herein may be implemented through a cloud platform, a server or a server group (hereinafter collectively the “service system”) that interacts with a client. The client may be a terminal device, or a client registered by a user at a platform, wherein the terminal device may be a mobile terminal, a personal computer (PC), and any device that may be installed with a platform application program.

The various features and processes described above may be used independently of one another or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The exemplary systems and components described herein may be configured differently than described. For example, elements may be added to, removed from, or rearranged compared to the disclosed example embodiments.

The various operations of exemplary methods described herein may be performed, at least partially, by an algorithm. The algorithm may be comprised in program codes or instructions stored in a memory (e.g., a non-transitory computer-readable storage medium described above). Such an algorithm may comprise a machine learning algorithm. In some embodiments, a machine learning algorithm may not explicitly program computers to perform a function but can learn from training data to make a prediction model that performs the function.

The various operations of exemplary methods described herein may be performed, at least partially, by one or more processors that are temporarily configured (e.g., by software) or permanently configured to perform the relevant operations. Whether temporarily or permanently configured, such processors may constitute processor-implemented engines that operate to perform one or more operations or functions described herein.

Similarly, the methods described herein may be at least partially processor-implemented, with a particular processor or processors being an example of hardware. For example, at least some of the operations of a method may be performed by one or more processors or processor-implemented engines. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the subject matter has been described with reference to specific example embodiments, various modifications and changes may be made to these embodiments without departing from the broader scope of embodiments of the present disclosure. Such embodiments of the subject matter may be referred to herein, individually or collectively, by the term “invention” merely for convenience and without intending to voluntarily limit the scope of this application to any single disclosure or concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

As used herein, “or” is inclusive and not exclusive, unless expressly indicated otherwise or indicated otherwise by context. Therefore, herein, “A, B, or C” means “A, B, C, A and B, A and C, B and C, or A, B, and C,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context. Moreover, plural instances may be provided for resources, operations, or structures described herein as a single instance. Additionally, boundaries between various resources, operations, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

The term “include” or “comprise” is used to indicate the existence of the subsequently declared features, but it does not exclude the addition of other features. Conditional language, such as, among others, “can,” “could,” “may,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

What is claimed is:

1. A testing apparatus for an interconnect under test, comprising:
a transmitter configured to generate a test signal;
an interconnect configured to couple the transmitter to the interconnect under test;
a signal-routing circuit comprising (1) a compensation path comprising a controllable compensation circuit and (2) a bypass path bypassing the controllable compensation circuit;
a measurement interface configured to receive signal-metric data corresponding to the test signal after propagation of the test signal through the interconnect under test; and
a controller configured to switch the signal-routing circuit between:
in a first mode, route the test signal through the compensation path and determine an inferred loss value representative of loss of the interconnect under test; and
in a second mode, route the test signal through the bypass path while bypassing the controllable compensation circuit, and determine a de-embedded performance metric of the interconnect under test.

2. The testing apparatus of claim 1, wherein in the first mode, the controller is further configured to:
adjust the controllable compensation circuit until first signal-metric data received from the measurement interface satisfies a reference condition, and
determine the inferred loss value based on an adjusted state of the controllable compensation circuit.

3. The testing apparatus of claim 1, wherein in the second mode, the controller is further configured to:
determine the de-embedded performance metric based on second signal-metric data received from the measurement interface and baseline de-embedding data associated with the interconnect.

4. The testing apparatus of claim 1, wherein the signal-routing circuit comprises an electronic switching element, and
the controller is configured to switch the signal-routing circuit between the first mode and the second mode via the electronic switching element without physical disconnection of the interconnect under test.

5. The testing apparatus of claim 2, wherein the controller is further configured to:
store compensation calibration data that correlates a plurality of control states of the controllable compensation circuit to a plurality of loss-compensation values,
each control state comprising one or more programmable settings of the controllable compensation circuit and each loss-compensation value representing a corresponding amount of channel-loss compensation provided by the controllable compensation circuit.

6. The testing apparatus of claim 5, wherein the controller is further configured to:
determine the inferred loss value by matching the adjusted state of the controllable compensation circuit to a corresponding loss-compensation value in the stored compensation calibration data, in response to that the first signal-metric data satisfies the reference condition.

7. The testing apparatus of claim 2, wherein the controllable compensation circuit comprises at least one of a redriver, a retimer, a continuous-time linear equalizer, a feed-forward equalizer, or a decision-feedback equalizer, and
the adjusted state comprises at least one of a gain setting, an equalization setting, a peaking setting, a tap-coefficient setting, or a digital register value of the controllable compensation circuit.

8. The testing apparatus of claim 1, wherein the controller is further configured to establish the reference condition prior to testing the interconnect under test by:
routing the test signal through a reference path comprising a target channel loss,
placing the controllable compensation circuit in a known reference state, and
measuring a baseline signal-integrity metric.

9. The testing apparatus of claim 1, wherein the first signal-metric data and the second signal-metric data comprise at least one of an eye height, an eye width, a vertical eye closure, a bit-error-rate estimate, or a multi-level signal metric, and
wherein the multi-level signal metric comprises at least one of a plurality of eye openings, a level-separation metric, or a linearity metric of a multi-level modulated signal.

10. The testing apparatus of claim 1, wherein the interconnect under test comprises a plurality of high-speed channels, and
wherein the controller is configured to execute the first mode on a specific channel of the plurality of high-speed channels while adjacent channels are in an inactive state, to determine a single-channel inferred loss value for the specific channel.

11. The testing apparatus of claim 10, wherein the controller is further configured to:
execute the first mode on the specific channel while the adjacent channels transmit active signal patterns to determine a multi-channel inferred loss value, the active signal patterns comprising at least one of pseudo-random binary sequences, compliance test patterns, stress patterns, or protocol traffic patterns.

12. The testing apparatus of claim 11, wherein the controller is further configured to determine a multi-channel impairment value associated with crosstalk by calculating a difference between the single-channel inferred loss value and the multi-channel inferred loss value,
the multi-channel impairment value representing an additional loss, margin reduction, or compensation requirement caused by simultaneous operation of multiple channels of the interconnect under test.

13. The testing apparatus of claim 1, wherein the controller is further configured to:
generate a per-cable quality determination by comparing the inferred loss value against a target loss specification and comparing the de-embedded performance metric against an active eye-mask threshold, and to classify the interconnect under test as passing, failing, or belonging to a predetermined quality bin based on the comparisons.

14. The testing apparatus of claim 1, wherein the controller is configured to:
aggregate the inferred loss value and the de-embedded performance metric across a batch of tested interconnects to compute a statistical process-capability indicator based on a distribution of at least one selected quality characteristic of the batch relative to one or more specification limits.

15. The testing apparatus of claim 14, wherein the controller is configured to:
issue a control action to upstream manufacturing equipment when the statistical process-capability indicator drops below a predetermined limit,
the control action comprising at least one of generating an alarm, causing sorting or isolation of a tested interconnect, stopping or pausing a production process, or transmitting a correction parameter to the upstream manufacturing equipment.

16. The testing apparatus of claim 1, wherein the baseline de-embedding data comprises at least one of S-parameters, a transfer function, a loss-versus-frequency table, a time-domain impulse response, a polynomial model, or a correction matrix characterizing signal effects of the interconnect.

17. The testing apparatus of claim 1, wherein the test signal complies with a high-speed serial communication protocol selected from the group consisting of Peripheral Component Interconnect Express (PCIe), Compute Express Link (CXL), Ethernet, InfiniBand, Universal Accelerator Link (UALink), Universal Serial Bus (USB), and Thunderbolt.

18. A method for testing an interconnect under test using a testing apparatus comprising a transmitter, an interconnect, a signal-routing circuit comprising a compensation path and a bypass path, a measurement interface, and a controller, the method comprising:
generating, by the transmitter, a test signal;
switching, by the controller, the signal-routing circuit between a first mode and a second mode;
in the first mode, routing the test signal through the compensation path, the interconnect, and the interconnect under test, the compensation path comprising a controllable compensation circuit, and determining an inferred loss value representative of loss of the interconnect under test; and
in the second mode, routing the test signal through the bypass path, the interconnect, and the interconnect under test while bypassing the controllable compensation circuit, and determining a de-embedded performance metric of the interconnect under test.

19. The method of claim 18, wherein determining the inferred loss value in the first mode comprises:
receiving, via the measurement interface, first signal-metric data corresponding to the test signal after propagation of the test signal through the interconnect under test;
adjusting, by the controller, the controllable compensation circuit until the first signal-metric data satisfies a reference condition; and
determining the inferred loss value based on an adjusted state of the controllable compensation circuit.

20. The method of claim 18, wherein determining the de-embedded performance metric in the second mode comprises:
receiving, via the measurement interface, second signal-metric data corresponding to the test signal after propagation of the test signal through the interconnect under test; and
determining the de-embedded performance metric based on the second signal-metric data and baseline de-embedding data associated with the interconnect.
